(19) United States
(12) Patent Application Publication
(10) Pub. No.: US 2017/0184197 A1
(43) Pub. Date: Jun. 29, 2017

(54) INTERLOCKING SYSTEM FOR TRANSMISSION STAMPED SHIFT SYSTEM

(71) Applicant: Eaton Corporation, Cleveland, OH (US)

(72) Inventor: Vinay Narayan KUMBHAR, Pune (IN)

(73) Assignee: Eaton Corporation, Cleveland, OH (US)

(21) Appl. No.: 15/358,231

(22) Filed: Nov. 22, 2016

Related U.S. Application Data
(60) Provisional application No. 62/299,118, filed on Feb. 24, 2016.
(60) Provisional application No. 62/302,964, filed on Mar. 3, 2016.

(30) Foreign Application Priority Data
Dec. 29, 2015 (IN) 4315/DEL/2015

(51) Int. Cl. F16H 63/36; F16H 63/08

(52) U.S. Cl. CPC F16H 63/36; F16H 63/08

(57) ABSTRACT

A shift system for a transmission includes a rail assembly, a first/second shift yoke, a third/fourth shift yoke, a fifth/sixth shift yoke and a reverse shift yoke. The rail assembly includes a first rail, a second rail, a third rail and a fourth rail. The first, second third and fourth rails are formed of stamped metal. The first/second shift yoke is supported by the first rail and configured to select first and second gears. The third/fourth shift yoke is supported by the second rail and configured to select third and fourth gears. The fifth/sixth shift yoke is supported by the third rail and is configured to select fifth and sixth gears. The reverse shift yoke is supported by the fourth rail and is configured to select a reverse gear.

### CROSS-REFERENCE TO RELATED APPLICATIONS

This application claims the benefit of Indian Provisional Application No. 4315/DEL/2015 filed Dec. 29, 2015, U.S. Provisional Application No. 62/299,118 filed Feb. 24, 2016; and U.S. Provisional Application No. 62/302,964 filed Mar. 3, 2016. The disclosures of the above applications are incorporated herein by reference.

### FIELD

The present disclosure relates generally to various features related to a stamped shift system of a transmission.

### BACKGROUND

Transmission shift assemblies allow a vehicle operator to selectively change gear ratios during vehicle operation. A manual shift assembly can be provided that allows a vehicle operator to determine when a shifting event is to be initiated. Typically many gear ratios are provided to provide a user a varied range of speeds to select during use. A manual transmission typically includes a shift knob that is movable between a plurality of shift positions such as first, second, third, fourth, fifth, sixth, etc. In addition, a reverse position is provided that allows a user to select a reverse gear. Typically such transmissions include shift rails comprising cylindrical shafts or rods that connect various yokes associated with corresponding gears. In many instances the arrangement of such rods takes up significant space within the transmission. It would be desirable to provide a shift assembly that allows efficient shifting, occupies less space within the transmission and is cost effective.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A shift system for a transmission includes a rail assembly, a first/second shift yoke, a third/fourth shift yoke, a fifth/sixth shift yoke and a reverse shift yoke. The rail assembly includes a first rail, a second rail, a third rail and a fourth rail. The first, second third and fourth rails are formed of stamped metal. The first/second shift yoke is supported by the first rail and configured to select first and second gears. The third/fourth shift yoke is supported by the second rail and configured to select third and fourth gears. The fifth/sixth shift yoke is supported by the third rail and is configured to select fifth and sixth gears. The reverse shift yoke is supported by the fourth rail and is configured to select a reverse gear.

According to additional features, the shift system includes a shift finger, a shift plunger assembly and an interlocking block. The shift finger, the shift plunger assembly and the interlocking block cooperate to permit movement of only one rail of the rail assembly at a time. The shift plunger assembly includes a shift finger collar that at least partially receives a shift plunger. The shift finger collar defines a cavity that receives a first biasing member and a second biasing member. The first and second biasing members provide stepped biasing onto the shift plunger. The interlocking block is made of formed metal. The interlocking block includes a plunger receiving portion that defines a blind bore configured to receive the shift plunger such that the shift finger is guided into the plunger receiving portion of the interlocking block. The interlocking block defines an elongated slot configured to receive the shift finger. The first rail defines a first rail slot. The second rail defines a second rail slot. The third rail defines a third rail slot. The fourth rail defines a fourth rail slot. The shift finger is configured to slide the interlocking block from a first slot from one of the first, second, third and fourth rail slots to a second slot from another of the first, second, third and fourth rail slots.

A shift system for a transmission according to other features of the present disclosure includes a rail assembly, a first/second shift yoke, a third/fourth shift yoke, a fifth/sixth shift yoke, a reverse shift yoke and a neutral actuation system. The rail assembly includes a first rail having a first rail passage, a second rail having a second rail passage, a third rail having a third rail passage and a fourth rail. The first, second, third and fourth rails are formed of stamped metal. The first/second shift yoke is supported by the first rail and is configured to select first and second gears. The third/fourth shift yoke is supported by the second rail and is configured to select third and fourth gears. The fifth/sixth shift yoke is supported by the third rail and is configured to select fifth and sixth gears. The reverse shift yoke is supported by the fourth rail and is configured to select a reverse gear. The neutral actuation system includes a neutral switch and a plurality of balls including a first ball, a second ball and a third ball that are disposed within the first, second and third passages, respectively. The first, second and third balls are biased into the neutral switch activating the neutral switch upon alignment of the first, second and third rail passages.

According to other features, the neutral actuation system further includes a biasing member that biases the plurality of balls toward the neutral switch. The fourth rail has a fourth rail passage that receives a pin disposed between the ball assembly and the neutral switch. The pin is disposed within a sleeve at the fourth rail passage. The biasing member is captured within a bushing. The neutral switch sends a signal to a controller upon activation.

A shift system for a transmission according to other features of the present disclosure includes a rail assembly, a first/second shift yoke, a third/fourth shift yoke, a fifth/sixth shift yoke, a reverse shift yoke and a roller ball. The rail assembly includes a first rail having a first rail passage, a second rail having a second rail passage, a third rail having a third rail passage and a fourth rail. The first, second, third and fourth rails are formed of stamped metal. The first/second shift yoke is supported by the first rail and is configured to select first and second gears. The third/fourth shift yoke is supported by the second rail and is configured to select third and fourth gears. The fifth/sixth shift yoke is supported by the third rail and is configured to select fifth and sixth gears. The reverse shift yoke is supported by the fourth rail and is configured to select a reverse gear. The roller ball is disposed in the first rail passage. The roller ball is positioned intermediate adjacent rails of the rail assembly and is configured to reduce friction therebetween upon movement of one of the rails of the rail assembly.

According to additional features, the first rail comprises a first pair of rail passages. A complementary first pair of roller balls is disposed in the first pair of rail passages. The second rail has a second pair of rail passages that receive a complementary second pair of roller balls. The second pair of roller balls is configured to reduce friction between adjacent rails of the rail assembly. The first rail further includes a third pair of rail passages that receive a complementary third pair of roller balls. The third pair of roller balls is configured to reduce friction between adjacent rails of the rail assembly. The second rail further includes a fourth pair of rail passages that receive a complementary fourth pair of roller balls. The fourth pair of roller balls is configured to reduce friction between adjacent rails of the rail assembly. A diameter of the ball is greater than a thickness of the first rail at the first rail passage. The roller ball has a diameter of 8.5 mm. The first rail has a thickness of 7.0 mm.

A shift system for a transmission according to other features of the present disclosure includes a rail assembly, a first/second shift yoke, a third/fourth shift yoke, a fifth/sixth shift yoke, a reverse shift yoke and a reverse gear switch. The rail assembly includes a first rail having a first rail passage, a second rail having a second rail passage, a third rail having a third rail passage and a fourth rail. The first, second, third and fourth rails are formed of stamped metal. The first/second shift yoke is supported by the first rail and is configured to select first and second gears. The third/fourth shift yoke is supported by the second rail and is configured to select third and fourth gears. The fifth/sixth shift yoke is supported by the third rail and is configured to select fifth and sixth gears. The reverse shift yoke is supported by the fourth rail and is configured to select a reverse gear. The reverse shift yoke has a reverse shift lug extending therefrom. The reverse gear switch is disposed on the shift housing and is configured to activate upon engagement with the reverse shift lug.

According to other features, the first/second shift yoke has a first shift lug extending therefrom. The shift system can further include a first gear switch disposed on the shift housing and configured to activate upon engagement with the first shift lug.

### BRIEF DESCRIPTION OF THE DRAWINGS

The present disclosure will become more fully understood from the detailed description and the accompanying drawings, wherein:

FIG. 1A illustrates a top perspective view of an interlocking system for a stamped shift system in a six speed transmission constructed in accordance to one example of the present disclosure;

FIG. 1B is a bottom perspective view of a shift bar housing of the stamped shift system of FIG. 1A;

FIG. 1C is a first partial detail perspective view of the rail assembly of the stamped shift system of FIG. 1A;

FIG. 1D is a second partial detail perspective view of the rail assembly of the stamped shift system of FIG. 1A;

FIG. 2A is a top perspective view of the shift rails of the interlocking system of FIG. 1;

FIG. 2B is a partial exploded view of the shift finger, interlocking block and plunger assembly of the stamped shift system;

FIG. 3A is a cross-sectional view of the shift plunger assembly and interlocking block shown in the 3^{rd}/4^{th} rail position;

FIG. 3B is a cross-sectional view of the shift plunger assembly and interlocking block shown in the 5^{th}/6th rail position;

FIG. 3C is a cross-sectional view of the shift plunger assembly and interlocking block shown in the 1^{st}/2nd rail position;

FIG. 3D is a cross-sectional view of the shift plunger assembly and interlocking block shown in the reverse rail position;

FIG. 4A is a top view of the shift plunger assembly and interlocking block shown in the 3^{rd}/4^{th} rail position;

FIG. 4B is a top view of the shift plunger assembly and interlocking block shown in the 5^{th}/6th rail position;

FIG. 4C is a top view of the shift plunger assembly and interlocking block shown in the 1^{st}/2^{nd} rail position;

FIG. 4D is a top view of the shift plunger assembly and interlocking block shown in the reverse rail position;

FIG. 5A is a bottom perspective view of the stamped shift assembly of FIG. 1;

FIG. 5B is a detail view of a C-clamp constructed in accordance to additional features and having an insert formed of reduced friction material;

FIG. 6A is a cross-sectional view of a neutral switch shown in an activated position;

FIG. 6B is a cross-sectional view of the neutral switch of FIG. 6A;

FIG. 7A is a cross-sectional view of a neutral switch shown in a deactivated position resulting from the shifted position of the 1^{st}/2^{nd} shift rail;

FIG. 7B is a cross-sectional view of a neutral switch shown in a deactivated position resulting from the shifted position of the 3^{rd}/4^{th} shift rail;

FIG. 7C is a cross-sectional view of a neutral switch shown in a deactivated position resulting from the shifted position of the 5^{th}/6^{th} shift rail;

FIG. 7D is a cross-sectional view of a neutral switch shown in a deactivated position resulting from the shifted position of the reverse shift rail;

FIG. 8A is a top view of a stamped shift system incorporating a roller ball assembly according to additional features of the present disclosure;

FIG. 8B is a top view of the rail assembly of the stamped shift system of FIG. 8A;

FIG. 8C is a side view of a first rail of the rail assembly of FIG. 8B;

FIG. 8D is a cross-sectional view of the rail assembly taken along lines 8D-8D of FIG. 8B;

FIG. 8E is a cross-sectional view of the rail assembly taken along lines 8E-8E of FIG. 8B;

FIG. 9 is a partial exploded view of the roller ball assembly of FIG. 8A;

FIG. 10 is a top perspective view of a stamped shift system constructed in accordance to additional features and having an actuating switch assembly;

FIG. 11 is a partial top perspective view of the stamped shift system of FIG. 10;

FIG. 12A is a top perspective view of the reverse gear switch in a deactivated position;

FIG. 12B is a top perspective view of the reverse gear switch in an activated position; and

FIG. 13 is a top perspective view of the first shift rail and first gear switch.

### DETAILED DESCRIPTION

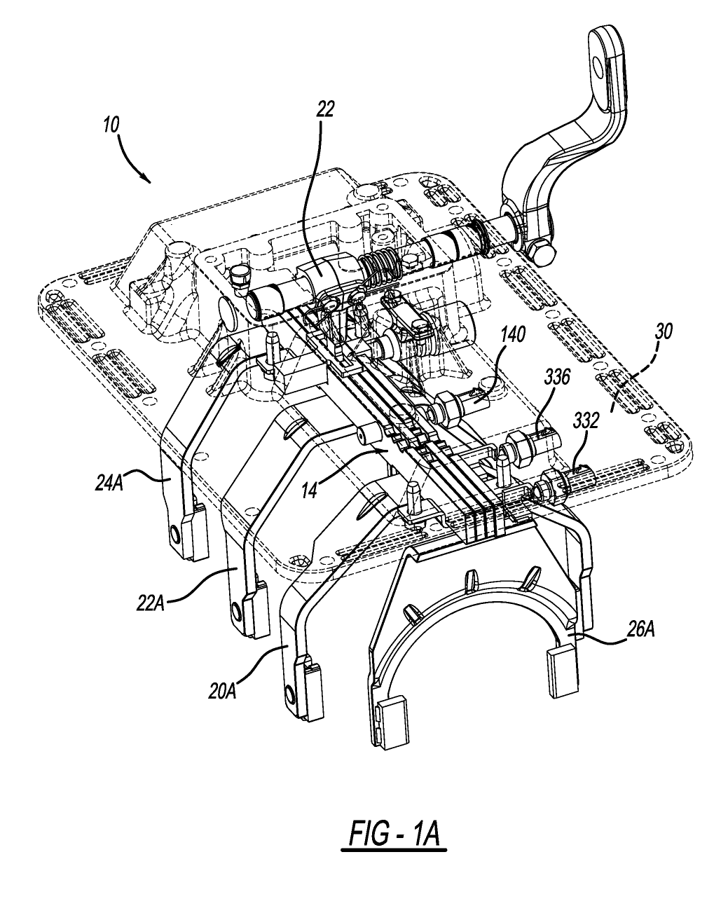

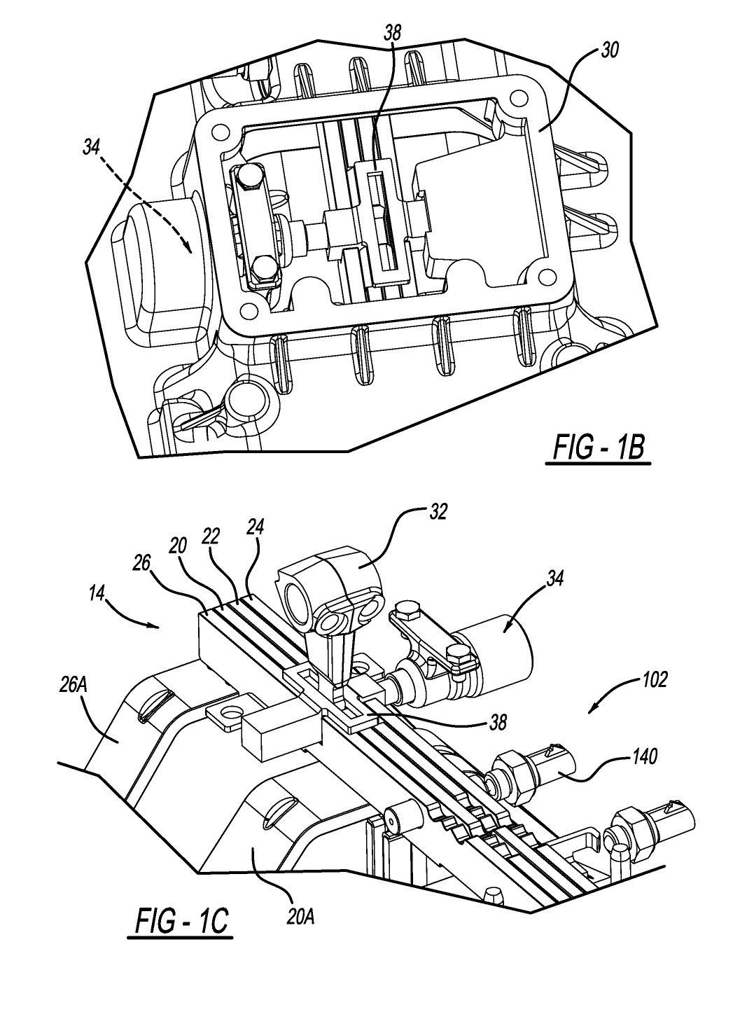

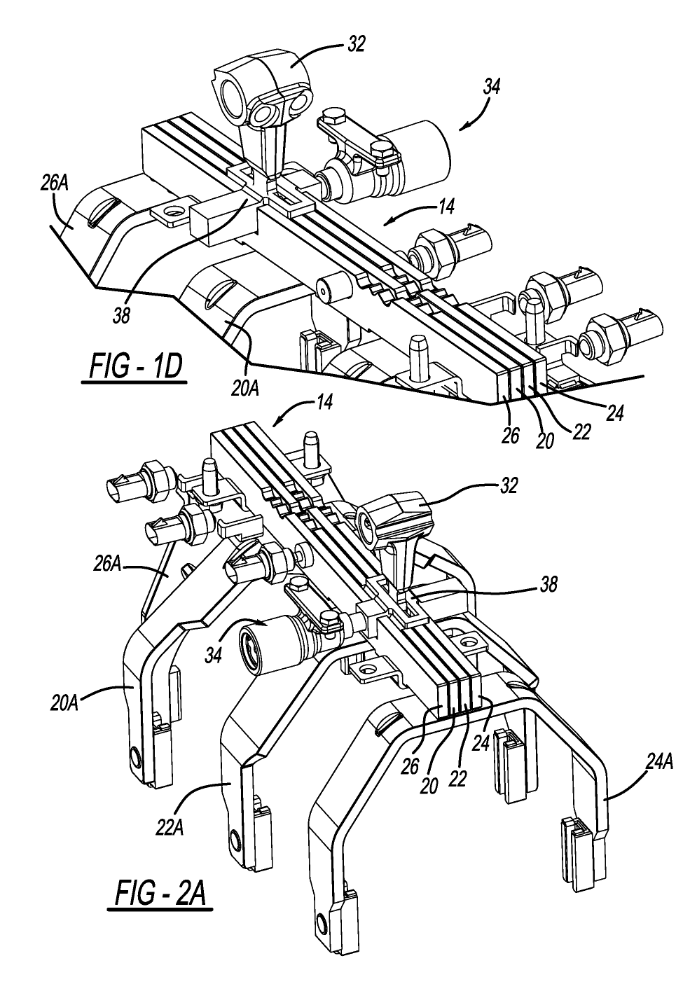

With initial reference to FIGS. 1-5B, a cost effective stamped shift system for a six-speed manual transmission is shown and generally identified at reference numeral 10. The shift system 10 comprises a rail assembly 14. The rail assembly 14 includes four rails; a first rail 20, a second rail 22, a third rail 24 and a fourth rail 26. The first rail 20 supports a first/second shift yoke 20A. The second rail 22 supports a third/fourth shift yoke 22A. The third rail 24 supports a fifth/sixth shift yoke 24A. The fourth rail 26 supports a reverse shift yoke 26A. The rail assembly 14 is assembled to cooperate with respective shift yokes to select forward gears and a reverse gear. Specifically, the first rail 20 and first/second shift yoke 20A may be used to select first and second forward gear. The second rail 22 and the third/fourth shift yoke 22A may be used to select third and fourth gear. The third rail 24 and fifth/sixth shift yoke 24A may be used to select fifth and sixth gear. The fourth rail 26 and reverse shift yoke 26A may be used to select a reverse gear. As best shown in FIG. 2B, the first rail 20 defines a first rail slot 20B, the second rail 22 defines a second rail slot 22B, the third rail 24 defines a third rail slot 24B and the fourth rail 26 defines a fourth rail slot 26B. The rails 20, 22, 24 and 26 are formed of stamped metal and each have a generally rectangular profile where adjacent rails oppose respective planar faces. The arrangement provides favorable packaging and operational benefits as will become appreciated from the following discussion.

The shift system 10 can be supported by a shift bar housing 30. A shift finger 32 and a shift plunger assembly 34 cooperate with an interlocking block 38 permitting movement of only one rail of the rail assembly 14 at a time. The shift plunger assembly 34 can generally include a shift finger collar 40 that at least partially receives a shift plunger 42. In the example shown, the shift finger collar 40 defines a cavity 44 that receives a first biasing member 46 and a second biasing member 48. A first snap ring 54 and a first plate 56 capture the first and second biasing members 46, 48 within the cavity 44. A second plate 58 is positioned intermediate the second biasing member 48 and the shift plunger 42.

The interlocking block 38 can be made of forging. The interlocking block 38 can include a plunger receiving portion 60 that defines a blind bore 62 configured to receive the shift plunger 42. The shift plunger 42 therefore is guided into the plunger receiving portion 60 of the interlocking block 38.

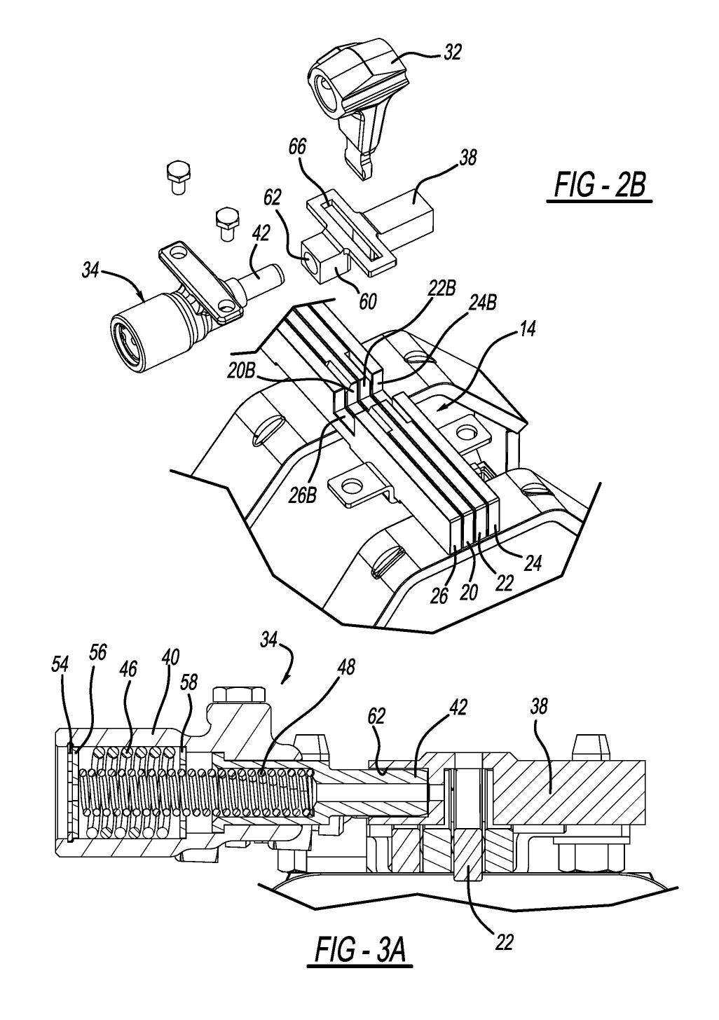

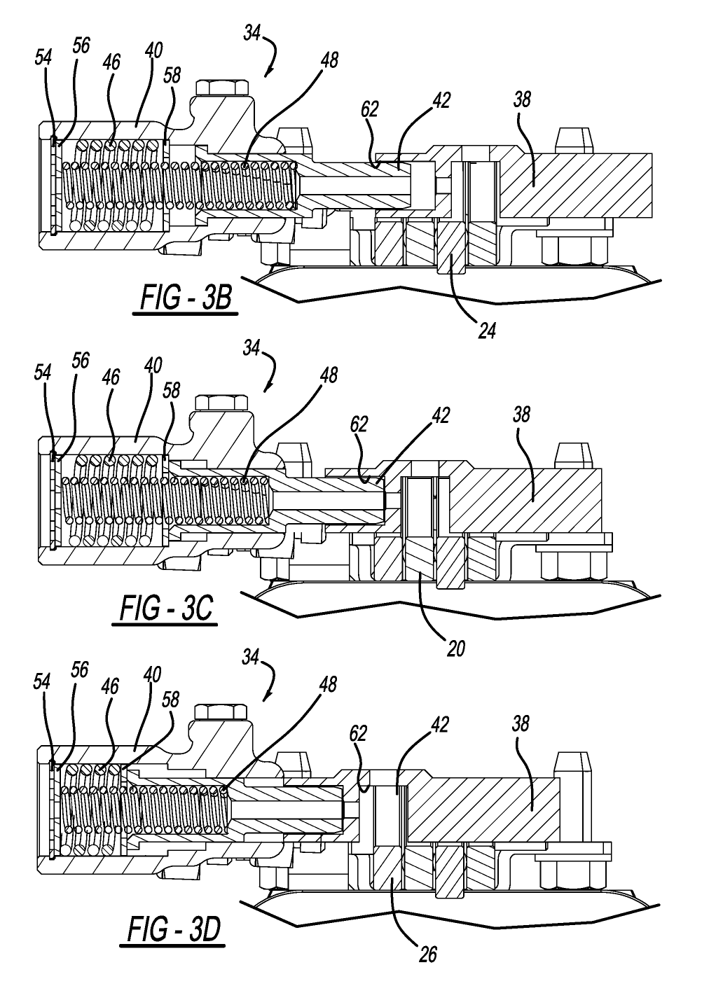

An elongated block slot 66 is formed through the interlocking block 38 that receives the shift finger 32. The shift finger 32 is guided into the block slot 66 and will slide the interlocking block 38 from a rail slot (20B, 22B, 24B, 26B) given on one rail (20, 22, 24 and 26) to a rail slot (20B, 22B, 24B, 26B) given on another rail (20, 22, 24 and 26). See FIGS. 2B-3D. Movement of one rail is permitted at a time, blocking the remaining rails due to the entangled position of the interlocking block 38 with the shift bar housing 30. The configuration precludes simultaneous shifting of multiple rails. The interlocking design is suitable for tower control, cable control, power assist, single lever, two lever, X-Y shifter and AMT.

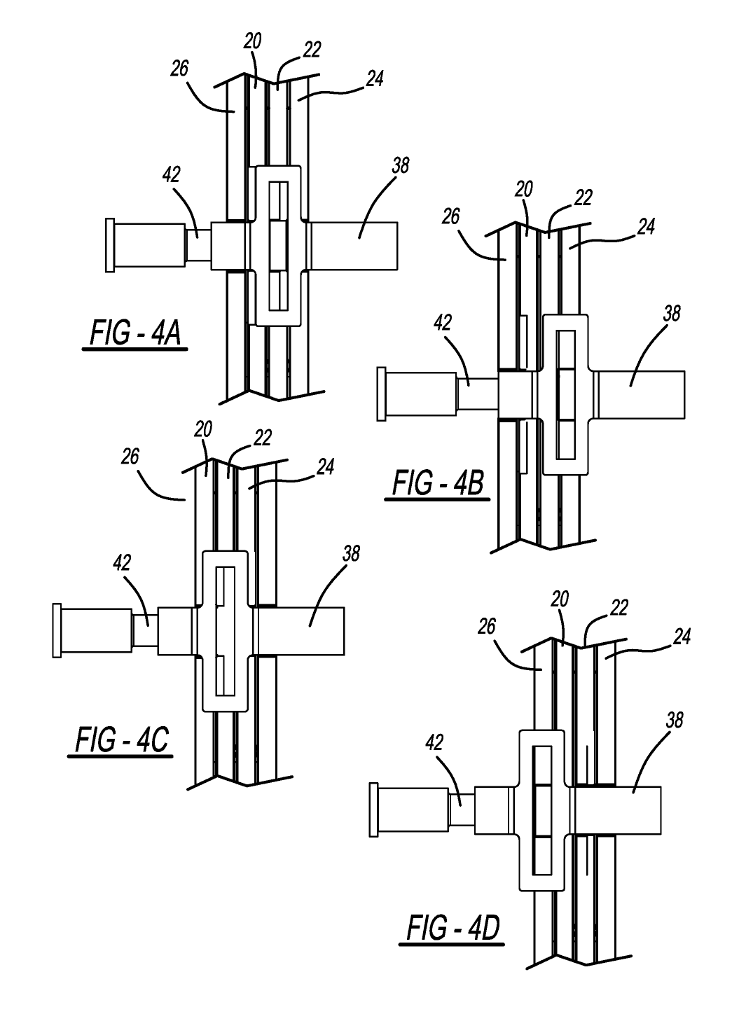

With particular reference to FIGS. 3A-4A, the interlocking block 38 is shown in the various rail positions. The plunger 42 can selectively depress one or both of the biasing members 46 and 48 to provide feedback to the user. In this regard, the first biasing member 46 must be at least partially compressed to successfully attain the reverse rail position. As can be appreciated, additional resistance to the operator is useful to identify a reverse gear is about to be selected.

A rail assembly constructed in accordance to one prior art configuration includes cylindrical rods that are spaced from each other a distance of 33 mm. For comparison, adjacent rails 20, 22, 24 and 26 are spaced 7.75 mm from each other offering a much more compact packaging arrangement.

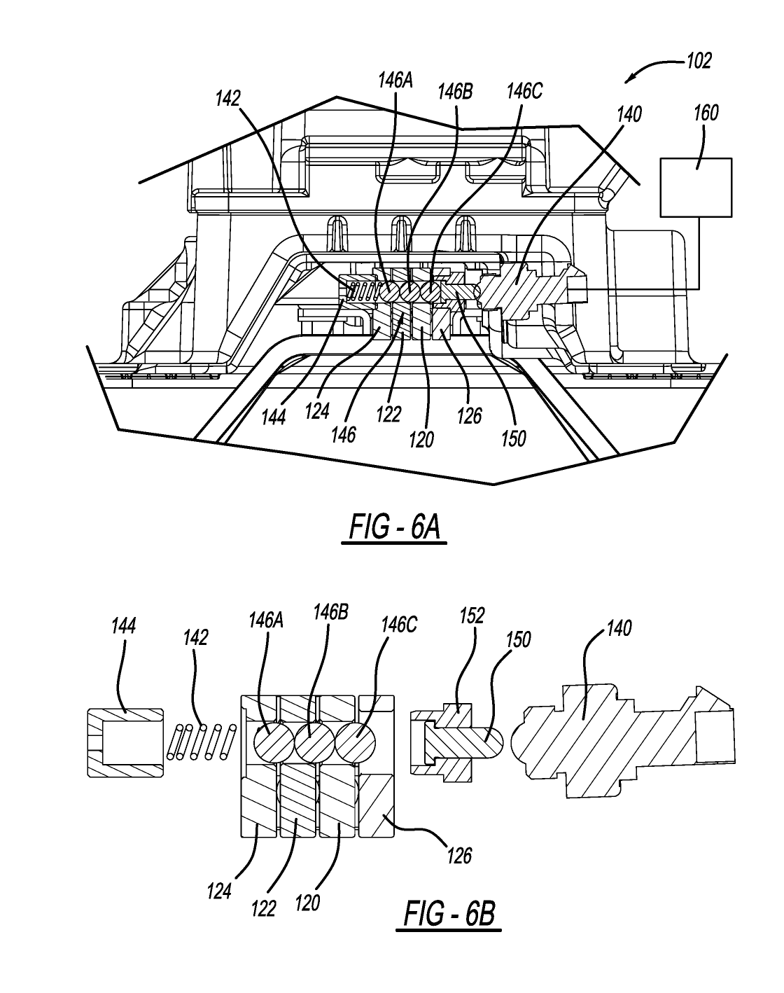

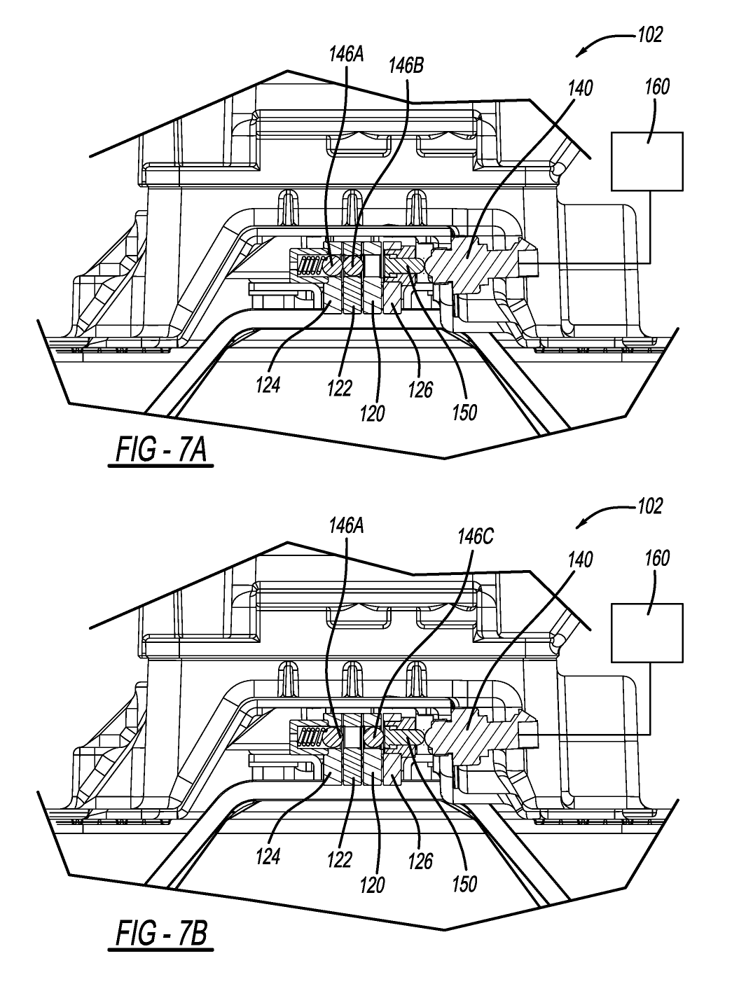

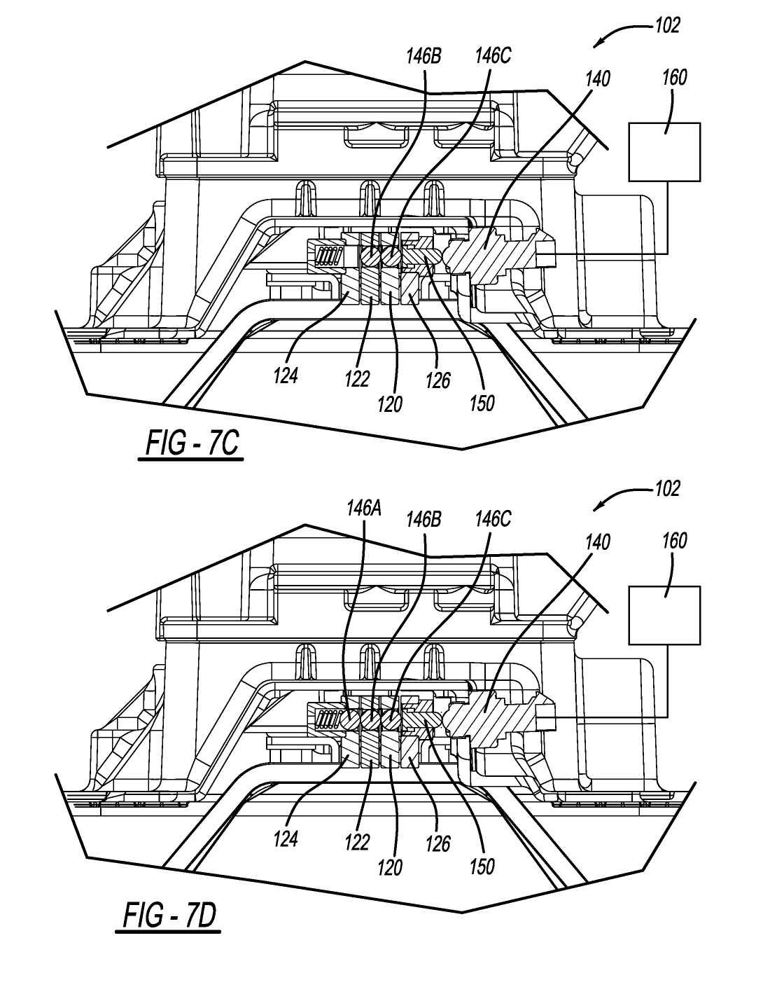

Turning now to FIGS. 6A-7D a neutral actuation system 102 constructed for use with a stamped shift system 110 will be described. The stamped shift system 110 may be constructed for use with a medium duty six speed transmission. Unless otherwise described, the stamped shift system 110 can be constructed similarly to the stamped shift system 10 described above.

The shift system 110 comprises a rail assembly 114. The rail assembly 114 includes four rails; a first rail 120, a second rail 122, a third rail 124 and a fourth rail 126. The first rail 120 supports a first/second shift yoke. The second rail 122 supports a third/fourth shift yoke. The third rail 124 supports a fifth/sixth shift yoke. The fourth rail 126 supports a reverse shift yoke. The rail assembly 114 is assembled to cooperate with respective shift yokes to select forward gears and a reverse. Specifically, the first rail 120 and first/second shift yoke may be used to select a first and second forward gear. The second rail 122 and the third/fourth shift yoke may be used to select third and fourth gear. The third rail 124 and fifth/sixth shift yoke may be used to select the fifth and sixth gear. The fourth rail 126 and reverse shift yoke may be used to select the reverse gear. As best shown in FIG. 7A-7D, the first rail 120 defines a first rail passage 120C, the second rail 122 defines a second rail passage 122C, the third rail 124 defines a third rail passage 124C and the fourth rail 126 defines a fourth rail passage 126C.

The neutral actuation system 102 generally includes a neutral switch 140, a biasing member 142, a bushing 144, a plurality of balls or spheres collectively referred to at reference 146, a pin 150 and a sleeve 152. In the example shown, the plurality of balls 146 comprises three balls, a first ball 146A, a second ball 146B and a third ball 146C. The first ball 146A generally locates at the first rail passage 120C. The second ball 146B generally locates at the second rail passage 122C. The third ball 146C generally locates at the third rail passage 124C. As will become appreciated herein, the respective balls 146 are configured to move laterally in their respective passages to engage an adjacent ball provided adjacent passages are aligned. The biasing member 142 is captured within the bushing 144.

The biasing member 142 biases the third ball 146C rightward and toward the neutral switch 140. When all of the first, second and third rail passages 120C, 122C and 124C align, each of the first, second and third balls 146A, 146B and 146C are permitted to engage each other. The biasing member 142 therefore urges the third ball 146C into the second ball 146B which is in turn urged into the first ball 146A. The first ball 146A translates the pin 150 rightward (as viewed in FIG. 6A) within the sleeve 152 and into the neutral switch 140. The neutral switch 140 then activates and sends a signal to a controller 160. The controller 160 can perform a function such as set a telltale on a vehicle dash conveying to the vehicle operator that the transmission is in “neutral”. The controller 160 can additionally or alternatively perform another function based on activation of the neutral switch 140.

The neutral actuation system 102 is designed to have an activating and deactivating switch stroke of 2.5 mm. The shift rail thickness is 7.0 mm. The gap between the two adjacent rails 120, 122, 124 and 126 can be 0.75 mm. A diameter of one of the balls 146A, 146B and 146C can be 8.0 mm. While the illustrations provide three roller balls other configurations are contemplated. The plunger pin 150 can have a collar 170 having a thickness of 2.0 mm. The biasing member 142 can be a compression spring having a length of 12.0 mm. Other dimensions and amounts of roller balls are contemplated.

As shown in FIG. 6A, the neutral switch 140 is shown in the activated position only when all three balls 146A, 146B and 146C are aligned. In this regard, when the first rail 120 is in a shifted position (FIG. 7A), the corresponding ball 146A is out of alignment with the second and third balls 146B and 146C precluding the pin 150 from translating rightward into the neutral switch 140. Similarly, when the second rail 122 is in a shifted position (FIG. 7B), the corresponding ball 146B is out of alignment with the first and third balls 146A and 146C precluding the pin 150 from translating rightward into the neutral switch 140. Likewise, when the third rail 124 is in a shifted position (FIG. 7C), the corresponding ball 146C is out of alignment with the first and second balls 146A and 146B precluding the pin 150 from translating rightward into the neutral switch. When the fourth rail 126 is in a shifted position (FIG. 7D), all three balls 146A, 146B and 146C are aligned, however, the fourth rail 126 is out of alignment precluding the first ball 146A from urging the plunger 150 rightward and into the neutral switch 140. The neutral actuation system 110 of the present disclosure requires less balls than prior art configurations, is more compact and more robust.

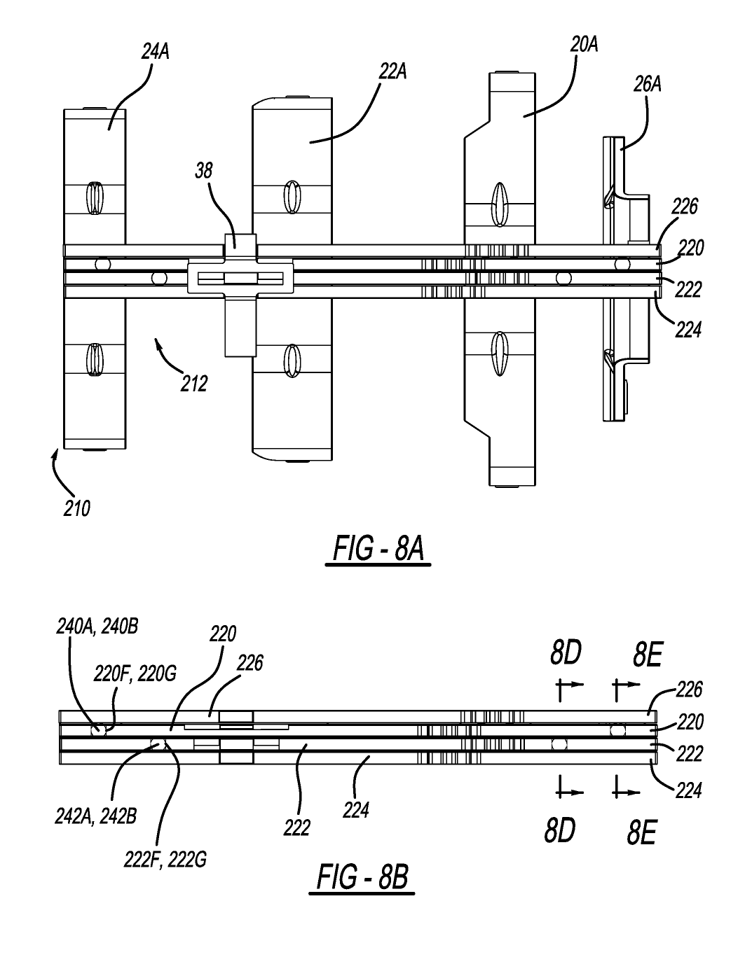

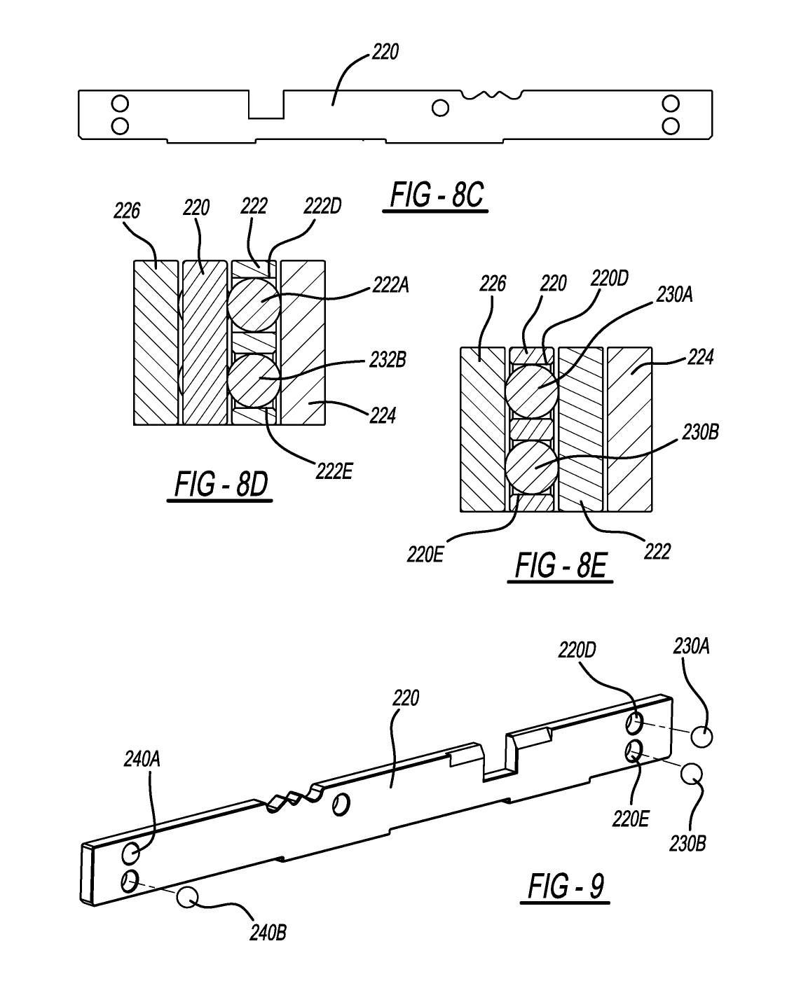

Turning now to FIGS. 8A-9 a stamped shift system 210 constructed in accordance to another example of the present disclosure will be described. The stamped shift system 210 may be constructed for use with a medium duty six-speed transmission. Unless otherwise described, the stamped shift system 210 can be constructed similarly to the stamped shift system 10 described above.

The stamped shift system 210 incorporates a roller ball assembly 212. As will be described, the roller ball assembly 212 can reduce friction between adjacent rails to help maintain shift efforts within limit. The shift system 210 comprises a rail assembly 214 (identified in FIGS. 8A and 8B). The rail assembly 214 includes four rails; a first rail 220, a second rail 222, a third rail 224 and a fourth rail 226. The first rail 220 supports a first/second shift yoke. The second rail 222 supports a third/fourth shift yoke. The third rail 224 supports a fifth/sixth shift yoke. The fourth rail 226 supports a reverse shift yoke. The rail assembly 214 is assembled to cooperate with respective shift yokes to select forward gears and a reverse gear. Specifically, the first rail 220 and first/second shift yoke may be used to select the first and second forward gear. The second rail 222 and the third/fourth shift yoke may be used to select the third and fourth gear. The third rail 224 and fifth/sixth shift yoke may be used to select fifth and sixth gear and the fourth rail 226. The reverse shift yoke may be used to select reverse gear. As best shown in FIGS. 8E and 9, the first rail 220 defines a first pair of rail passages 220D and 220E. The second rail 222 defines a pair of second rail passages 222D and 222E (FIG. 8D).

The roller ball assembly 212 further includes a first pair of rolling balls 230A and 230B and a second pair of roller balls 232A and 232B. The first pair of rolling balls 230A and 230B locate in the first pair of rail passages 220D and 220E. The second pair of rolling balls 232A and 232B locate in the second pair of rail passages 222D and 222E. The first pair of rolling balls 230A and 230B are configured to roll against the adjacent second rail 222 and fourth rail 226 to minimize friction. Similarly, the second pair of rolling balls 232A and 232B are configured to roll against the adjacent first rail 220 and third rail 224 to minimize friction.

The roller ball assembly 212 can further include a third pair of rolling balls 240A and 240B and a fourth pair of roller balls 242A and 242B. The third pair of rolling balls 240A and 240B locate in a third pair of rail passages 220F and 220G. The fourth pair of rolling balls 242A and 242B locate in a fourth pair of rail passages 222F and 222G. The third pair of rolling balls 240A and 240B are configured to roll against the adjacent second rail 222 and fourth rail 226 to minimize friction. Similarly, the fourth pair of rolling balls 242A and 242B are configured to roll against the adjacent first rail 220 and third rail 224. The first and third pair of rolling balls 230A, 230B, 240A, 240B all are guided by the first rail 220. Likewise, the second and fourth pair of rolling balls 232A, 232B, 242A, 242B are all guided by the second rail 222.

In one example, the roller balls 220A, 220B, 230A, 230B, 232A, 232B, 242A and 242B are 8.5 mm in diameter. In one configuration, the first pair of rolling balls 230A and 230B are spaced apart from the third pair of rolling balls 240A and 240B a first distance. The second pair of rolling balls 232A and 232B are spaced apart from the fourth pair of rolling balls 242A and 2242B a second distance. The first and second distances can be distinct so that the balls of the first and third pair of balls do not engage the balls of the second and fourth pair of balls. In other examples, the balls are offset so as not to interfere with each other.

As shown in FIGS. 8A-9, the roller balls are provided between the shift rails. As identified above, the roller balls can have an outer diameter of 8.5 mm. The 8.5 mm is selected to be greater than the rail thickness of 7.0 mm. Friction is reduced between the rails 220, 222, 224 and 226. The friction will be line contact between the roller balls 220A, 220B, 230A, 230B, 232A, 232B, 242A and 242B and the rails 220, 222, 224 and 226. Shift effort will be reduced. Shift quality will be at least as good as current configuration. Eight roller balls 230A, 230B, 240A, 240B, 232A, 232B, 242A and 242B are provided. Four roller balls 230A, 230B, 240A, 240B are assembled in 1^{st}/2^{nd} rail 220 and the remaining four roller balls 232A, 232B, 242A and 242B are assembled in the 3^{rd}/4^{th} rail 222. A symmetrical gap of 0.75 mm is maintained in all four rails along the rail length. The length of each rail can be 330 mm. Other dimensions are contemplated. When the shift bars of the prior art translate, they slidably engage the housing and support plate in three locations creating unfavorable friction.

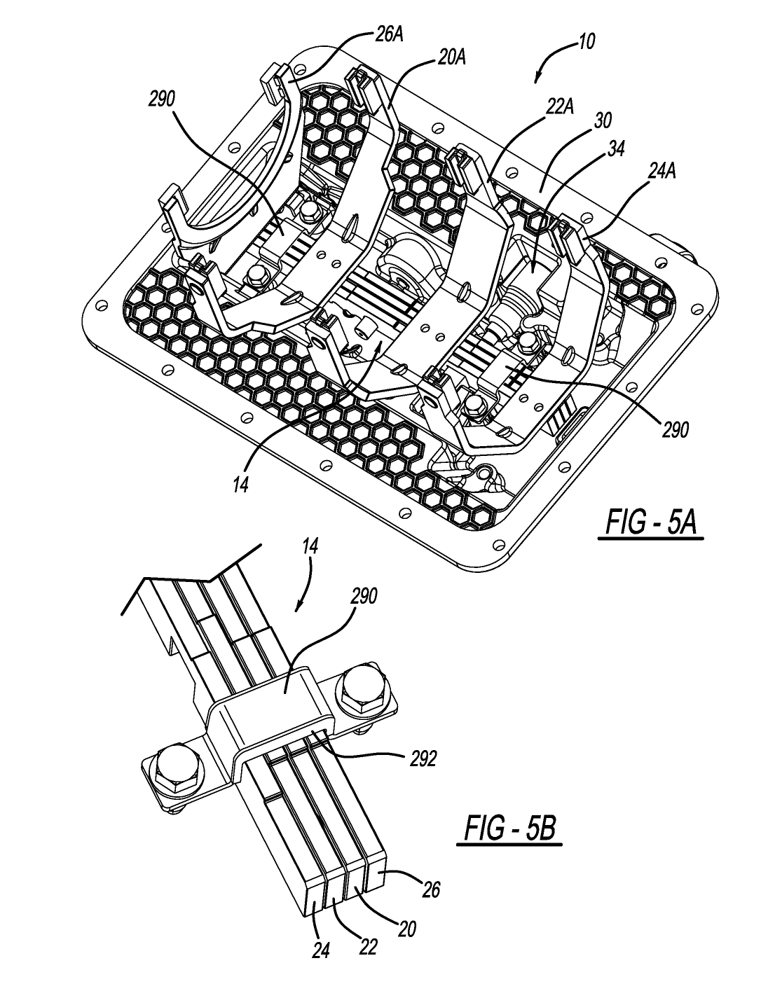

Turning now to FIGS. 5A and 5B, additional features of the stamped shift system 210 will be described. A pair of C-clamps 290 are provided for clamping shift rail assembly 214 to the housing 218. Both C-clamps 290 can be formed of stamped metal having an insert 292 formed of reduced friction material such as, but not limited to Stanyl nylon. In one configuration, the roller balls 230A, 230B, 240A, 240B, 232A, 232B, 242A and 242B are placed in the corresponding shift rails 220 and 222 proximate to the C-clamps 290 so that if any one of the rails 220, 222, 224 or 226 moves, it will give the linear baring movement to adjacent rails.

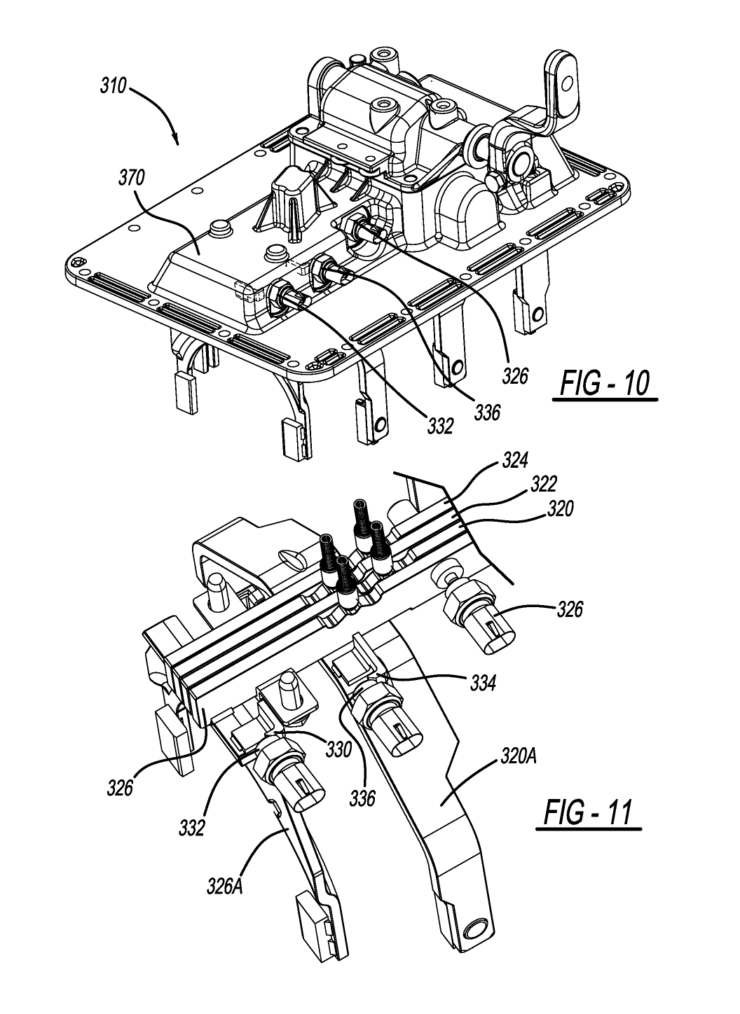

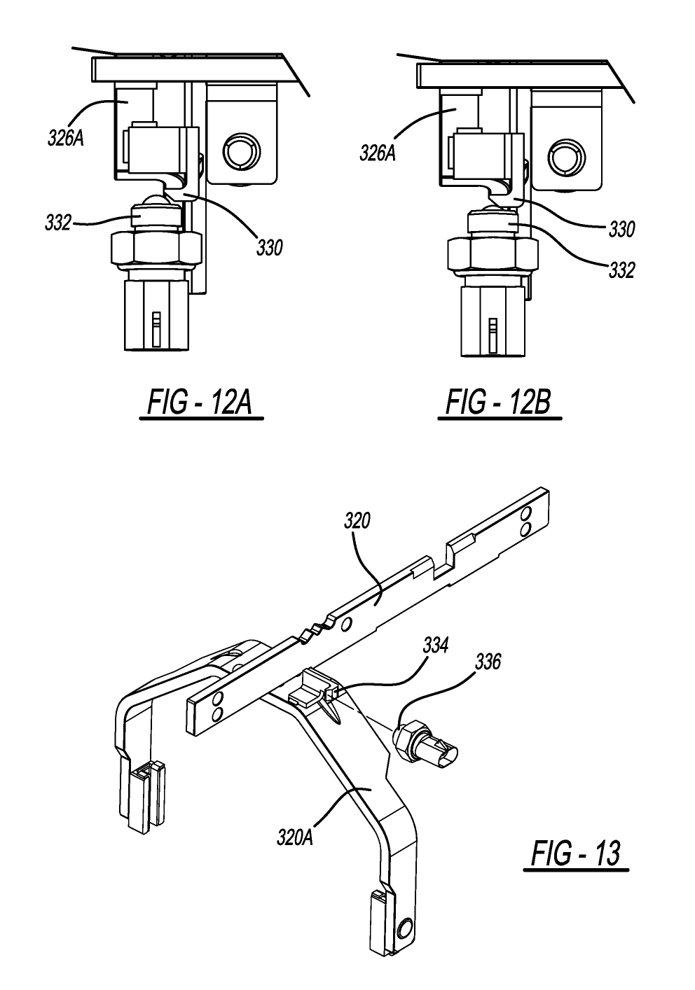

With reference now to FIGS. 10-13, a stamped shift system 310 constructed in accordance to another example of the present disclosure will be described. The stamped shift system 310 may be constructed for use with a medium duty six-speed transmission. Unless otherwise described, the stamped shift system 310 can be constructed similarly to the stamped shift system 10 described above.

The stamped shift system 310 incorporates an actuating switch assembly 312 for gear selection. The shift system 310 comprises a rail assembly 314. The rail assembly 314 includes four rails; a first rail 320, a second rail 322, a third rail 324 and a fourth rail 326. The first rail 320 supports a first/second shift yoke 320A. The second rail 322 supports a third/fourth shift yoke 322A. The third rail 324 supports a fifth/sixth shift yoke (not specifically shown, but see FIG. 1C). The fourth rail 326 supports a reverse shift yoke 326A. The rail assembly 314 is assembled to cooperate with respective shift yokes to select forward gears and a reverse gear. Specifically, the first rail 320 and the first/second shift yoke 320A may be used to select the first and second forward gears. The second rail 322 and the third/fourth shift yoke 322A may be used to select the third and fourth gears. The third rail 324 and the fifth/sixth shift yoke may be used to select fifth and sixth gear. The fourth rail 326 and the reverse shift yoke 326A may be used to select the reverse gear.

The reverse shift yoke 326A includes a lug 330 that is configured to engage a reverse gear switch 332. Similarly, the first/second shift yoke 320A includes a lug 334 that is configured to engage a first gear switch 336. The reverse gear switch 332 or first gear switch 336 activates when depressed by the respective lug 330 or 334 and sends a signal to a controller 360. The controller 360 can perform a function such as set a telltale on a vehicle dash and/or perform another function based on activation of the respective switch 332, 336.

A new shift bar housing 370 accommodates the stamped shift system 310 with redesigned features. All three switches (reverse switch 332, first gear switch 336 and neutral switch, see 140, FIG. 6A) are provided on the shift bar housing 370. To operate these switches (reverse and first), a unique combination of yokes and lugs are provided. The lug can be welded to the yoke to actuate a respective reverse and first switch 332, 336.

The foregoing description of the examples has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

What is claimed is:

1. A shift system for a transmission, the shift system comprising:
a rail assembly including a first rail, a second rail, a third rail and a fourth rail, the first, second, third and fourth rails being formed of stamped metal;
a first/second shift yoke supported by the first rail and configured to select first and second gears;
a third/fourth shift yoke supported by the second rail and configured to select third and fourth gears;
a fifth/sixth shift yoke supported by the third rail and configured to select fifth and sixth gears; and
a reverse shift yoke supported by the fourth rail and configured to select a reverse gear.

2. The shift system of claim 1, further comprising:
a shift finger;
a shift plunger assembly; and
an interlocking block, wherein the shift finger, the shift plunger assembly and the interlocking block cooperate to permit movement of only one rail of the rail assembly at a time.

3. The shift system of claim 2 wherein the shift plunger assembly includes a shift finger collar that at least partially receives a shift plunger.

4. The shift system of claim 3 wherein the shift finger collar defines a cavity that receives a first biasing member and a second biasing member, the first and second biasing members providing stepped biasing onto the shift plunger.

5. The shift system of claim 3 wherein the interlocking block is made of forged metal.

6. The shift system of claim 3 wherein the interlocking block includes a plunger receiving portion that defines a blind bore configured to receive the shift plunger such that the shift finger is guided into the plunger receiving portion of the interlocking block.

7. The shift system of claim 6 wherein the interlocking block defines an elongated slot configured to receive the shift finger.

8. The shift system of claim 7 wherein the first rail defines a first rail slot, the second rail defines a second rail slot, the third rail defines a third rail slot and the fourth rail defines a fourth rail slot.

9. The shift system of claim 8 wherein the shift finger is configured to slide the interlocking block from a first slot from one of the first, second, third and fourth rail slots to a second slot from another of the first, second, third and fourth rail slots.

10. A shift system for a transmission, the shift system comprising:
a rail assembly including a first rail having a first rail passage, a second rail having a second rail passage, a third rail having a third rail passage and a fourth rail, the first, second, third and fourth rails being formed of stamped metal;
a first/second shift yoke supported by the first rail and configured to select first and second gears;
a third/fourth shift yoke supported by the second rail and configured to select third and fourth gears;
a fifth/sixth shift yoke supported by the third rail and configured to select fifth and sixth gears;
a reverse shift yoke supported by the fourth rail and configured to select a reverse gear;
a neutral actuation system including a neutral switch and a plurality of balls including a first ball, a second ball and a third ball that are disposed within the first, second and third passages, respectively; and
wherein the first, second and third balls are biased into the neutral switch activating the neutral switch upon alignment of the first, second and third rail passages.

11. The neutral actuation system of claim 10 wherein the neutral actuation system further includes a biasing member that biases the plurality of balls toward the neutral switch.

12. The neutral actuation system of claim 11 wherein the fourth rail has a fourth rail passage that receives a pin disposed between the ball assembly and the neutral switch.

13. The neutral actuation system of claim 12 wherein the pin is disposed within a sleeve at the fourth rail passage.

14. The neutral actuation system of claim 11 wherein the biasing member is captured within a bushing.

15. The neutral actuation system of claim 10 wherein the neutral switch sends a signal to a controller upon activation.

16. A shift system for a transmission, the shift system comprising:
a rail assembly including a first rail having a first rail passage, a second rail, a third rail and a fourth rail, the first, second, third and fourth rails being formed of stamped metal;
a first/second shift yoke supported by the first rail and configured to select first and second gears;
a third/fourth shift yoke supported by the second rail and configured to select third and fourth gears;
a fifth/sixth shift yoke supported by the third rail and configured to select fifth and sixth gears;
a reverse shift yoke supported by the fourth rail and configured to select a reverse gear; and
a roller ball disposed in the first rail passage, the roller ball positioned intermediate adjacent rails of the rail assembly and configured to reduce friction therebetween upon movement of one of the rails of the rail assembly.

17. The shift system of claim 16 wherein the first rail comprises a first pair of rail passages and wherein a complementary first pair of roller balls are disposed in the first pair of rail passages.

18. The shift system of claim 16 wherein the second rail has a second pair of rail passages that receive a complementary second pair of roller balls, the second pair of roller balls configured to reduce friction between adjacent rails of the rail assembly.

19. The shift system of claim 17 wherein the first rail further includes a third pair of rail passages that receive a complementary third pair of roller balls, the third pair of roller balls configured to reduce friction between adjacent rails of the rail assembly.

20. The shift system of claim 19 wherein the second rail further includes a fourth pair of rail passages that receive a complementary fourth pair of roller balls, the fourth pair of roller balls configured to reduce friction between adjacent rails of the rail assembly.

21. The shift system of claim 16 wherein a diameter of the ball is greater than a thickness of the first rail at the first rail passage.

22. The shift system of claim 16 wherein the roller ball has a diameter of 8.5 mm and wherein the first rail has a thickness of 7.0 mm.

23. A shift system for a transmission, the shift system comprising:
a rail assembly supported by a shift housing and including a first rail, a second rail, a third rail and a fourth rail, the first, second, third and fourth rails being formed of stamped metal;
a first/second shift yoke supported by the first rail and configured to select first and second gears;
a third/fourth shift yoke supported by the second rail and configured to select third and fourth gears;
a fifth/sixth shift yoke supported by the third rail and configured to select fifth and sixth gears;
a reverse shift yoke supported by the fourth rail and configured to select a reverse gear, the reverse shift yoke having a reverse shift lug extending therefrom; and
a reverse gear switch disposed on the shift housing and configured to activate upon engagement with the reverse shift lug.

24. The shift system of claim 23 wherein the first/second shift yoke has a first shift lug extending therefrom.

25. The shift system of claim 24, further comprising:
a first gear switch disposed on the shift housing and configured to activate upon engagement with the first shift lug.
